(19) United States
(12) Patent Application Publication
(10) Pub. No.: US 2014/0119088 A1
(43) Pub. Date: May 1, 2014

(54) THREE-LEVEL INVERTER AND POWER SUPPLY EQUIPMENT

(71) Applicant: Huawei Technologies Co., Ltd., Shenzhen (CN)

(72) Inventors: Gouyi CHEN, Shenzhen (CN); Zhaoxue CUI, Shenzhen (CN); Tao ZHANG, Shenzhen (CN)

(73) Assignee: Huawei Technologies Co., Ltd., Shenzhen (CN)

(21) Appl. No.: 14/141,162

(22) Filed: Dec. 26, 2013

Related U.S. Application Data
(63) Continuation of application No. PCT/CN2013/074678, filed on Apr. 25, 2013.

(30) Foreign Application Priority Data
Oct. 29, 2012 (CN) 201210419552.7

(51) Int. Cl. H02M 7/538

(52) U.S. Cl. CPC H02M 7/53803
USPC 363/134

(57) ABSTRACT

The present application provides a three-level inverter and power supply equipment, including: a first IGBT, where a collector thereof is connected to a positive direct current bus, an emitter thereof is connected to a first connection point, and the collector and the emitter are bridge-connected to a first freewheeling diode; a second IGBT, where a collector thereof is connected to the first connection point, an emitter thereof is connected to a second connection point, and the collector and the emitter are bridge-connected to a second freewheeling diode; a third IGBT, where a collector thereof is connected to the second connection point, an emitter thereof is connected to a third connection point, and the collector and the emitter are bridge-connected to a third freewheeling diode; a fourth IGBT, where a collector thereof is connected to the third connection point, an emitter thereof is connected to a negative direct current bus.

### CROSS-REFERENCE TO RELATED APPLICATIONS

This application is a continuation of International Patent Application No. PCT/CN2013/074678, filed on Apr. 25, 2013, which claims priority to Chinese Patent Application No. 201210419552.7, filed on Oct. 29, 2012, both of which are hereby incorporated by reference in their entireties.

### FIELD OF THE APPLICATION

The present application relates to the field of power electronics technologies, and in particular, to a three-level inverter and power supply equipment.

### BACKGROUND OF THE APPLICATION

An inverter is a converting device for converting direct current electric energy of a direct current voltage source to alternating current electric energy by controlling turn-on and turn-off of switch tubes, and is an important part of the uninterruptible power system (UPS), in the solar energy technology and the wind power generation technology. Currently, the switch tubes generally are power semiconductor components such as a metal-oxide-semiconductor field-effect transistor (Metal-Oxide-Semiconductor Field-Effect Transistor, MOSFET) and an insulated gate bipolar transistor (Insulated Gate Bipolar Transistor, IGBT).

The inverter has various topological structures, where a diode neutral point clamping three-level inverter (referred to as a three-level inverter hereinafter) is widely used because it is simple in circuit topological structure, convenient to control, and low in costs. In the three-level inverter, each bridge arm has four switch tubes, four freewheeling diodes, and two clamping diodes. Generally, the two switch tubes connected to a direct current voltage source are called outer switch tubes, and the two switch tubes connected in series between the two outer switch tubes are called inner switch tubes. In the three-level inverter, each phase has three types of switch states, that is, N, O and P, and corresponding output voltages are −Udc/2, 0 and Udc/2, respectively, and therefore the inverter is called a three-level inverter, where Udc/2 is the voltage of the direct current power source.

In an existing technical solution, all the four switch tubes of the three-level inverter are IGBTs with the same performance. However, the total losses of the IGBTs of this type of three-level inverter are large, and the conversion efficiency of the inverter is low.

### SUMMARY OF THE APPLICATION

Embodiments of the present application provide a three-level inverter and power supply equipment, which are capable of improving conversion efficiency of the inverter.

In the first aspect, a three-level inverter is provided, including: a first insulated gate bipolar transistor IGBT, where a collector of the first IGBT is connected to a positive direct current bus, an emitter of the first IGBT is connected to a first connection point (or node), and the collector and the emitter of the first IGBT are bridge-connected to a first freewheeling diode; a second IGBT, where a collector of the second IGBT is connected to the first connection point, an emitter of the second IGBT is connected to a second connection point, and the collector and the emitter of the second IGBT are bridge-connected to a second freewheeling diode; a third IGBT, where a collector of the third IGBT is connected to the second connection point, an emitter of the third IGBT is connected to a third connection point, and the collector and the emitter of the third IGBT are bridge-connected to a third freewheeling diode; a fourth IGBT, where a collector of the fourth IGBT is connected to the third connection point, an emitter of the fourth IGBT is connected to a negative direct current bus, and the collector and the emitter of the fourth IGBT are bridge-connected to a fourth freewheeling diode; a first clamping diode, connected to the fourth connection point and the first connection point; a second clamping diode, connected to the fourth connection point and the third connection point, where the fourth connection point is a neutral potential point, the second connection point is an alternating current output connection point, switching speeds of the first IGBT and the fourth IGBT are higher than switching speeds of the second IGBT and the third IGBT, or saturation turn-on voltage drops of the second IGBT and the third IGBT are lower than saturation turn-on voltage drops of the first IGBT and the fourth IGBT.

In a first possible implementation manner, turn-off losses of the first IGBT and the fourth IGBT are smaller than turn-off losses of the second IGBT and the third IGBT; or turn-on losses of the first IGBT and the fourth IGBT are smaller than turn-on losses of the second IGBT and the third IGBT; or turn-off time of the first IGBT and the fourth IGBT is shorter than turn-off time of the second IGBT and the third IGBT; or turn-on time of the first IGBT and the fourth IGBT is shorter than turn-on time of the second IGBT and the third IGBT; or saturation turn-on voltage drops of the second IGBT and the third IGBT are lower than saturation turn-on voltage drops of the first IGBT and the fourth IGBT.

With reference to any one of the above possible implementation manners, in a second possible implementation manner, the three-level inverter further includes: a low-pass filter, connected between the second connection point and a load, and configured to filter an alternating current signal output by the second connection point.

With reference to any one of the above possible implementation manners, in a third possible implementation manner, the three-level inverter further includes: a controller, where an output end thereof is connected to a grid electrode of the first IGBT, a grid electrode of the second IGBT, a grid electrode of the third IGBT, and a grid electrode of the fourth IGBT; and the controller is configured to control the turn-on and turn-off of the first IGBT, the second IGBT, the third IGBT, and the fourth IGBT according to a preset pulse width modulation rule, so as to output the alternating current signal at the second connection point.

With reference to any one of the above possible implementation manners, in a fourth possible implementation manner, the three-level inverter further includes: a first capacitor, connected between the positive direct current bus and the fourth connection point; and a second capacitor, connected between the negative direct current bus and the fourth connection point.

In the other aspect, power supply equipment is provided, including: a three-level inverter and a direct current voltage source, where a positive pole of the direct current voltage source is connected to a positive direct current bus, and a negative pole of the direct current voltage source is connected to a negative direct current bus, where the three-level inverter includes: a first insulated gate bipolar transistor IGBT, where a collector of the first IGBT is connected to the positive direct current bus, an emitter of the first IGBT is connected to a first connection point, and the collector and the emitter of the first IGBT are bridge-connected to a first freewheeling diode; a second IGBT, where a collector of the second IGBT is connected to the first connection point, an emitter of the second IGBT is connected to a second connection point, and the collector and the emitter of the second IGBT are bridge-connected to a second freewheeling diode; a third IGBT, where a collector of the third IGBT is connected to the second connection point, an emitter of the third IGBT is connected to a third connection point, the collector and the emitter of the third IGBT are bridge-connected to a third freewheeling diode; a fourth IGBT, where a collector of the fourth IGBT is connected to the third connection point, an emitter of the fourth IGBT is connected to a negative direct current bus, and the collector and the emitter of the fourth IGBT are bridge-connected to a fourth freewheeling diode; a first clamping diode, connected to a fourth connection point and the first connection point; and a second clamping diode, connected to the fourth connection point and the third connection point, where the fourth connection point is a neutral potential point, the second connection point is an alternating current output connection point, switching speeds of the first IGBT and the fourth IGBT are higher than switching speeds of the second IGBT and the third IGBT, or saturation turn-on voltage drops of the second IGBT and the third IGBT are lower than saturation turn-on voltage drops of the first IGBT and the fourth IGBT.

In a first possible implementation manner, turn-off losses of the first IGBT and the fourth IGBT are smaller than turn-off losses of the second IGBT and the third IGBT; or turn-on losses of the first IGBT and the fourth IGBT are smaller than turn-on losses of the second IGBT and the third IGBT; or turn-off time of the first IGBT and the fourth IGBT is shorter than turn-off time of the second IGBT and the third IGBT; or turn-on time of the first IGBT and the fourth IGBT is shorter than turn-on time of the second IGBT and the third IGBT.

With reference to any one of the above possible implementation manners, in a second possible implementation manner, the three-level inverter further includes: a low-pass filter, connected between the second connection point and a load, and configured to filter an alternating current signal output by the second connection point.

With reference to any one of the above possible implementation manners, in a third possible implementation manner, the three-level inverter further includes: a controller, where an output end of the controller is connected to a grid electrode of the first IGBT, a grid electrode of the second IGBT, a grid electrode of the third IGBT, and a grid electrode of the fourth IGBT; and the controller is configured to control the turn-on and turn-off of the first IGBT, the second IGBT, the third IGBT, and the fourth IGBT according to a preset pulse width modulation rule, so as to output the alternating current signal at the second connection point.

With reference to any one of the above possible implementation manners, in a fourth possible implementation manner, the three-level inverter further includes: a first capacitor, connected between the positive direct current bus and the fourth connection point; and a second capacitor, connected between the negative direct current bus and the fourth connection point.

In the technical solution, the first IGBT and the fourth IGBT are high-speed IGBTs, having the features of very short tail current and low turn-off loss, and the high-speed IGBTs may significantly reduce the turn-off losses of the first IGBT and the fourth IGBT, thereby reducing the total losses of the IGBTs, and improving the conversion efficiency of the inverter. Or, the saturation turn-on voltage drops of the second IGBT and the third IGBT are lower than the saturation turn-on voltage drops of the first IGBT and the fourth IGBT, which reduces the turn-on losses of the second IGBT and the third IGBT, thereby reducing the total losses of the IGBTs, and improving the conversion efficiency of the inverter.

### BRIEF DESCRIPTION OF DRAWINGS

To illustrate the technical solutions in the embodiments of the present application more clearly, the following briefly introduces the accompanying drawings required for describing the embodiments of the present application. Apparently, the accompanying drawings in the following description show merely some embodiments of the present application, and a person of ordinary skill in the art may still derive other drawings from these accompanying drawings without creative efforts.

FIG. 1 is a schematic circuit structural diagram of an uninterruptible power system according to an embodiment of the present application;

FIG. 2 is a schematic circuit structural diagram of a three-level inverter according to an embodiment of the present application;

FIG. 3 is a schematic circuit structural diagram of a three-level inverter according to another embodiment of the present application;

FIG. 4 is a schematic circuit structural diagram of a three-level inverter according to yet another embodiment of the present application;

FIG. 5 is a sequence diagram of a control signal of a three-level inverter according to an embodiment of the present application; and

FIG. 6 is a schematic structural diagram of power supply equipment 600 according to an embodiment of the present application.

### DETAILED DESCRIPTION OF THE EMBODIMENTS

The following clearly and completely describes the technical solutions in the embodiments of the present application with reference to the accompanying drawings in the embodiments of the present application. Apparently, the described embodiments are merely a part rather than all of the embodiments of the present application. All other embodiments obtained by a person of ordinary skill in the art according to the embodiments of the present application without creative efforts shall fall within the protection scope of the present application.

The switching speed of a power semiconductor component affects electrical performance of an inverter in the following two aspects: in one aspect, the faster the switching speed is, the lower the switching loss is, and the higher the conversion efficiency of the inverter is; in the other aspect, the faster the switching speed is, the larger the voltage stress is when the switch tubes are turned off, and the less reliable the switch tubes are. Therefore, improving the switching speed is in conflict with reducing the switching losses and the voltage stresses of the switch tubes, and it is generally necessary to reasonably balance the switching speed in practical applications.

In order to improve the conversion efficiency of the inverter and reduce the voltage stresses of the switch tubes, the outer switch tubes may be Mosfets, while the inner switch tubes may be IGBTs. However, the backward recovery property of Mosfet body diodes is very poor, when the Mosfet body diodes are required to freewheel, the voltage spike generated by backward recovery of the body diodes not only increases the voltage stress of the Mosfets themselves, but also, increases the loss. Therefore, it is necessary to control the turn-on and turn-off of the switch tubes of the inverter in a complicated manner. For example, it is necessary to detect the direction of the current to prevent the current from freewheeling via the Mosfet body diodes.

The embodiments of the present application provide a three-level inverter that is simple to control and is capable of improving the conversion efficiency of the inverter and reducing the voltage stresses of the switch tubes, so that the switching speeds of the four switch tubes of the three-level inverter reach a reasonable balance.

The three-level inverter of the embodiments of the present application may be applied to all types of power supply equipment, for example, an uninterruptible power system, transducer, wind power generation equipment, and solar energy power generation equipment. The application scenarios of the three-level inverter are described by using the uninterruptible power system as an example.

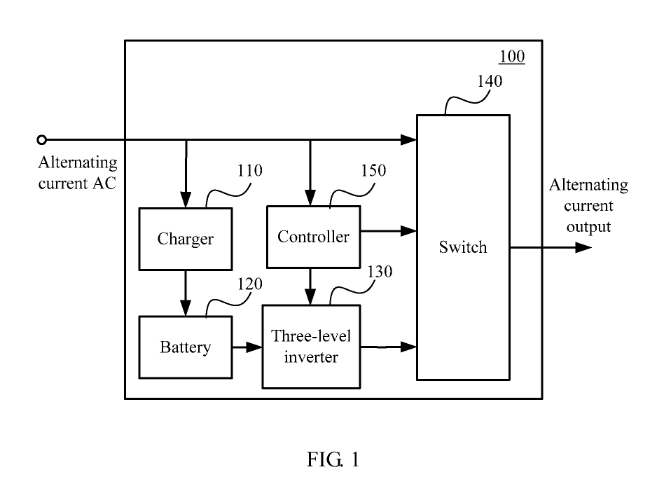

FIG. 1 is a schematic circuit structural diagram of an uninterruptible power system 100 according to an embodiment of the present application. The uninterruptible power system 100 includes: a charger 110, a battery 120, a three-level inverter 130, a switch 140, and a controller 150.

The charger 110 receives a first alternating current, and charges the battery 120 by using the first alternating current. The three-level inverter 130 receives a direct current (DC) from the battery 120, and converts the DC into a second alternating current. The switch 140 receives the first alternating current and the second alternating current, and outputs the first alternating current or the second alternating current to a load according to a control signal. The controller 150 detects the first alternating current, and outputs a control signal according to a detection result.

For example, the charger 110 receives an alternating current input by an alternating current (AC) (for example, an AC of 220 V), and charges the battery 120. The three-level inverter 130 receives the DC input by the battery 120, and is configured to convert the DC input by the battery 120 into an alternating current under the control of the controller 150. The switch 140 receives the alternating currents input by the AC and the three-level inverter 130, selects one alternating current from the alternating currents input by the AC and the three-level inverter 130 under the control of the controller 150, and sends the selected alternating current to the load. The controller 150 detects the voltage of the AC, and controls the switching operation of the switch 140 according to a detection result of the AC. For example, when the AC is missing or unstable, the controller 150 outputs the alternating current input by the three-level inverter 130 to the load; and when the AC is normal, the controller 150 outputs the alternating current input by the AC to the load, so as to uninterruptibly provide the load with a stable and reliable alternating current.

It should be understood that, the circuit structure of the uninterruptible power system is used only for describing the connection relation between the three-level inverter and the uninterruptible power system, and the embodiments according to the present application are not limited to the uninterruptible power system having the above circuit structure. For example, in the controller 150, the part for controlling the three-level inverter 130 may also be integrated into the three-level inverter 130.

The three-level inverter according to the embodiments of the present application is described in detail hereinafter.

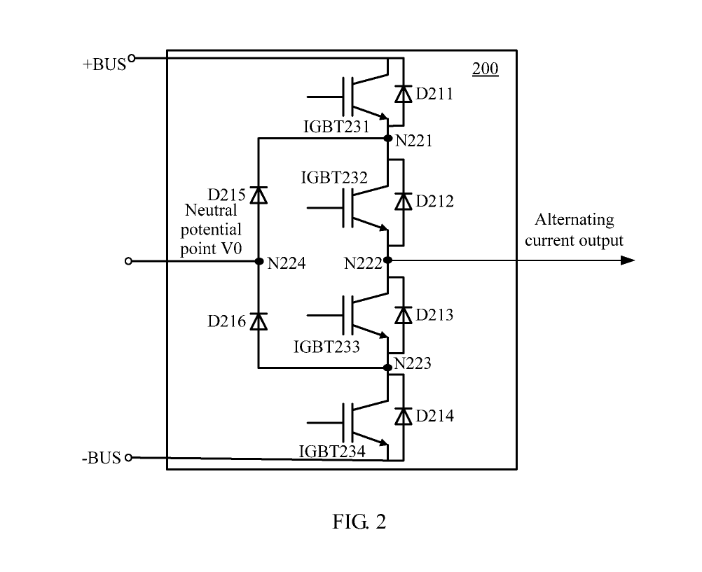

FIG. 2 is a schematic circuit structural diagram of a three-level inverter 200 according to an embodiment of the present application. The three-level inverter 200 is an example of the three-level inverter 130 in FIG. 1. The three-level inverter 200 includes: a first IGBT 231, a second IGBT 232, a third IGBT 233, a fourth IGBT 234, a first clamping diode D215, and a second clamping diode D216.

A collector of the first IGBT 231 is connected to a positive DC bus +BUS. For example, a positive pole V+ of a DC voltage source, and an emitter of the first IGBT 231 is connected to a first connection point N221. The collector and the emitter of the first IGBT 231 are bridge-connected to a first freewheeling diode D211. For example, an anode of the first freewheeling diode D211 is connected to the emitter of the first IGBT 231, and a cathode of the first freewheeling diode D211 is connected to the collector of the first IGBT 231.

A collector of the second IGBT 232 is connected to the first connection point N221, and an emitter of the second IGBT 232 is connected to a second connection point N222. The collector and the emitter of the second IGBT 232 are bridge-connected to a second freewheeling diode D212. For example, an anode of the second freewheeling diode D212 is connected to the emitter of the second IGBT 232, and a cathode of the second freewheeling diode D212 is connected to the collector of the second IGBT 232.

A collector of the third IGBT 233 is connected to the second connection point N222, an emitter of the third IGBT 233 is connected to a third connection point N223, and the collector and the emitter of the third IGBT 233 are bridge-connected to a third freewheeling diode D213. For example, an anode of the third freewheeling diode D213 is connected to the emitter of the third IGBT 233, and a cathode of the third freewheeling diode D213 is connected to the collector of the third IGBT 233.

A collector of the fourth IGBT 234 is connected to the third connection point N223, and an emitter of the fourth IGBT 234is connected to a negative DC bus −BUS, for example, a negative pole V− of the DC voltage source. The collector and the emitter of the fourth IGBT 234 are bridge-connected to a fourth freewheeling diode D214. For example, an anode of the fourth freewheeling diode D214 is connected to an emitter of the fourth IGBT 234, and a cathode of the fourth freewheeling diode D214 is connected to the collector of the fourth IGBT 234.

The first clamping diode D215 is connected to a fourth connection point N224 and the first connection point N221. For example, an anode of the first clamping diode D215 is connected to the fourth connection point N224, and a cathode of the first clamping diode D215 is connected to the first connection point N221. The second clamping diode D216 is connected to the fourth connection point N224 and the third connection point N223. For example, a cathode of the second clamping diode D216 is connected to the fourth connection point N224, and an anode of the second clamping diode D216 is connected to the third connection point N223. The fourth connection point N224 is a neutral potential point, the second connection point N222 is an alternating current output connection point, switching speeds of the first IGBT 231 and the fourth IGBT 234 are higher than switching speeds of the second IGBT 232 and the third IGBT 233, or saturation turn-on voltage drops of the second IGBT 232 and the third IGBT 233 are lower than saturation turn-on voltage drops of the first IGBT 231 and the fourth IGBT 234.

According to the embodiments of the present application, the first IGBT and the fourth IGBT are high-speed IGBTs, having the features of very short tail current and low turn-off loss, and the high-speed IGBTs are capable of significantly reducing the turn-off losses of the first IGBT and the fourth IGBT; while the second IGBT and the third IGBT are low-speed IGBTs, having the features of low saturation turn-on voltage drop and slow turn-off speed, and the low-speed IGBTs are capable of reducing the turn-on losses of the second IGBT and the third IGBT, thereby reducing the total losses of the IGBTs, and improving the conversion efficiency of the inverter. Or, the saturation turn-on voltage drops of the second IGBT and the third IGBT are lower than the saturation turn-on voltage drops of the first IGBT and the fourth IGBT, which reduces the turn-on losses of the second IGBT and the third IGBT, thereby reducing the total losses of the IGBTs, and improving the conversion efficiency of the inverter.

Meanwhile, because the backward recovery property of the freewheeling diodes bridge-connected to the first IGBT and the fourth IGBT is better than that of the Mosfet body diodes, it is unnecessary to control the switch tubes in a manner as complicated as the solution where the outer switch tubes are Mosfets, so that the switch tubes can be controlled in a simple controlling manner.

Further, because the price of the IGBT is lower than that of the Mosfet, the costs of the three-level inverter in the embodiments of the present application are lower than the solution of adopting the Mosfet.

According to the embodiments of the present application, the first IGBT and the fourth IGBT are high-speed IGBTs, and the second IGBT and the third IGBT are low-speed IGBTs.

The switching speeds of the IGBTs may be distinguished by comparing the switch property parameters (for example, switching time and switching loss) of the IGBTs under the same test conditions, for example, the same grid electrode drive circuit, test circuit, and component junction temperature. For example, the turn-off loss of a high-speed IGBT is smaller than the turn-off loss of a low-speed IGBT, or the turn-on loss of a high-speed IGBT is smaller than the turn-on loss of a low-speed IGBT, or the turn-off time of a high-speed IGBT is shorter than the turn-off time of a low-speed IGBT, or the turn-on time of a high-speed IGBT is shorter than the turn-on time of a low-speed IGBT. The turn-on loss, turn-off loss, turn-off time, turn-on time, and saturation turn-on voltage drop herein are the switch property parameters of the IGBTs, that is, the parameters tested and obtained by an IGBT manufacturer by switching on the IGBTs each in the same test circuit, but not the parameters actually measured after the IGBTs are used in the three-level inverter in the embodiments of the present application. These switch property parameters generally may be obtained from the component specification of the IGBT manufacturer. It should be understood that, when the switch property parameters are compared, a same test circuit may be built in a lab if the test conditions of two IGBT switches on the specification are different, so as to compare the switch property parameters of the IGBTs under the same test conditions.

According to the embodiments of the present application, the turn-off losses of the first IGBT and the fourth IGBT are smaller than the turn-off losses of the second IGBT and the third IGBT.

Optionally, as another embodiment, the turn-on losses of the first IGBT and the fourth IGBT are smaller than the turn-on losses of the second IGBT and the third IGBT.

For example, a switching loss may include a turn-on loss and a turn-off loss.

Optionally, as another embodiment, the turn-off time of the first IGBT and the fourth IGBT is shorter than the turn-off time of the second IGBT and the third IGBT.

Optionally, as another embodiment, the turn-on time of the first IGBT and the fourth IGBT is shorter than the turn-on time of the second IGBT and the third IGBT.

For example, a switching time may include a turn-on time Ton and a turn-off time Toff. The turn-on time Ton includes the rise time tr (Rise time) and the turn-on delay time Td(on) (Turn-on delay time), that is, Ton=tr+Td(on). The turn-off time Toff includes the fall time tf (Fall time) and the turn-off delay time Td(off) (Turn-off delay time), that is, Td(off)=tf+Td(off).

It should be understood that, the embodiments of the present application set no limitation on which of the above switch property parameters is used to define the high-speed IGBT and the low-speed IGBT, and the high-speed IGBT and the low-speed IGBT may be defined by using a combination of any one or more of the turn-on loss, turn-off loss, turn-off time, and turn-on time. For example, in the embodiments of the present application, an IGBT having a small turn-off loss and a small turn-on loss may be taken as a high-speed IGBT, and an IGBT having a large turn-off loss and a large turn-on loss may be taken as a low-speed IGBT. Definitely, an IGBT having a small turn-off loss and a large turn-on loss may be taken as a high-speed IGBT, and an IGBT having a large turn-off loss and a small turn-on loss may be taken as a low-speed IGBT.

Optionally, as another embodiment, the saturation turn-on voltage drops of the second IGBT and the third IGBT are lower than the saturation turn-on voltage drops of the first IGBT and the fourth IGBT.

For example, the saturation turn-on voltage drop of an IGBT corresponds to the turn-on loss, that is, the smaller the saturation turn-on voltage drop is, the smaller the turn-on loss is.

Optionally, as another embodiment, the three-level inverter 200 further includes: a controller (not shown), where an output end of the controller is connected to a grid electrode of the first IGBT, a grid electrode of the second IGBT, a grid electrode of the third IGBT, and a grid electrode of the fourth IGBT; and the controller is configured to control the turn-on and turn-off of the first IGBT 231, the second IGBT 232, the third IGBT 233, and the fourth IGBT 234 according to a preset pulse width modulation rule, so as to output an alternating current signal at the second connection point N222.

For example, pulse width modulation pulses output by a pulse width modulator may be output to the grid electrodes of the first IGBT 231, the second IGBT 232, the third IGBT 233, and the fourth IGBT 234, so as to drive these IGBTs.

Optionally, as another embodiment, the three-level inverter 200 may further include a low-pass filter, connected between the second connection point and a load, and configured to filter an alternating current signal output by the second connection point.

For example, the low-pass filter may include a circuit composed of a capacitor and/or an inductor.

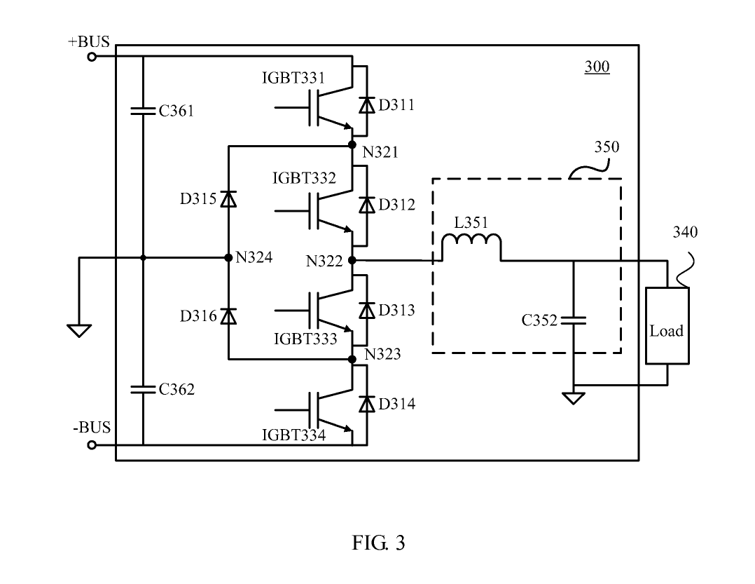

FIG. 3 is a schematic circuit structural diagram of a three-level inverter 300 according to another embodiment of the present application. The three-level inverter 300 includes: a first IGBT 331, a second IGBT 332, a third IGBT 333, a fourth IGBT 334, a first clamping diode D315, and a second clamping diode D316. The three-level inverter 300 in FIG. 3 is an example of the three-level inverter 200 in FIG. 2, and detailed descriptions herein are not provided properly.

A collector of the first IGBT 331 is connected to a positive pole of a DC voltage source, that is, is connected to a positive bus +BUS of the DC voltage source, and an emitter of the first IGBT 331 is connected to a first connection point N321. The collector and the emitter of the first IGBT 331 are bridge-connected to a first freewheeling diode D311. For example, an anode of the first freewheeling diode D311 is connected to the emitter of the first IGBT 331, and a cathode of the first freewheeling diode D311 is connected to the collector of the first IGBT 331.

A collector of the second IGBT 332 is connected to the first connection point N321, and an emitter of the second IGBT 332 is connected to a second connection point N322. The collector and the emitter of the second IGBT 332 are bridge-connected to a second freewheeling diode D312. For example, an anode of the second freewheeling diode D312 is connected to the emitter of the second IGBT 332, and a cathode of the second freewheeling diode D312 is connected to the collector of the second IGBT 332.

A collector of the third IGBT 333 is connected to the second connection point N322, and an emitter of the third IGBT 333 is connected to a third connection point N323. The collector and the emitter of the third IGBT 333 are bridge-connected to a third freewheeling diode D313. For example, an anode of the third freewheeling diode D313 is connected to the emitter of the third IGBT 333, and a cathode of the third freewheeling diode D313 is connected to the collector of the third IGBT 333.

A collector of the fourth IGBT 334 is connected to the third connection point N323, and an emitter of the fourth IGBT 334 is connected to a negative pole of the DC voltage source, that is, is connected to a negative bus −BUS of the DC voltage source. The collector and the emitter of the fourth IGBT 334 are bridge-connected to a fourth freewheeling diode D314. For example, an anode of the fourth freewheeling diode D314 is connected to the emitter of the fourth IGBT 334, and a cathode of the fourth freewheeling diode D314 is connected to the collector of the fourth IGBT 334.

The first clamping diode D315 is connected to the fourth connection point N324 and the first connection point N321. For example, an anode of the first clamping diode D315 is connected to the fourth connection point N324, and a cathode of the first clamping diode D315 is connected to the first connection point N321. The second clamping diode D316 is connected to the fourth connection point N324 and the third connection point N323. For example, a cathode of the second clamping diode D316 is connected to the fourth connection point N324, and an anode of the second clamping diode D316 is connected to the third connection point N323, where the fourth connection point N324 is a neutral potential point, and the second connection point N322 is an alternating current output connection point, switching speeds of the first IGBT 331 and the fourth IGBT 334 are higher than switching speeds of the second IGBT 332 and the third IGBT 333, or saturation turn-on voltage drops of the second IGBT 332 and the third IGBT 333 are lower than saturation turn-on voltage drops of the first IGBT 331 and the fourth IGBT 334.

Optionally, as another embodiment, the three-level inverter 300 may further include: a low-pass filter 350, connected between the second connection point N322 and a load 340. The low-pass filter may include a capacitor and/or an inductor. For example, the low-pass filter 350 may include an inductor L351 and a capacitor C352, where the inductor L351 and the load 340 are connected in series, the capacitor 352 and the load 340 are connected in parallel, an end of the capacitor 352 and an end of the load 340 are connected to the inductor 351, and the other ends are connected to the neutral point.

Optionally, as another embodiment, the three-level inverter 300 may further include: a first capacitor 361 and a second capacitor 362. The first capacitor 361 is connected between the positive bus +BUS of the DC voltage source and the fourth connection point N324. The second capacitor 362 is connected between the negative bus −BUS of the DC voltage source and the fourth connection point N324, where the fourth connection point N324 is connected to the neutral point.

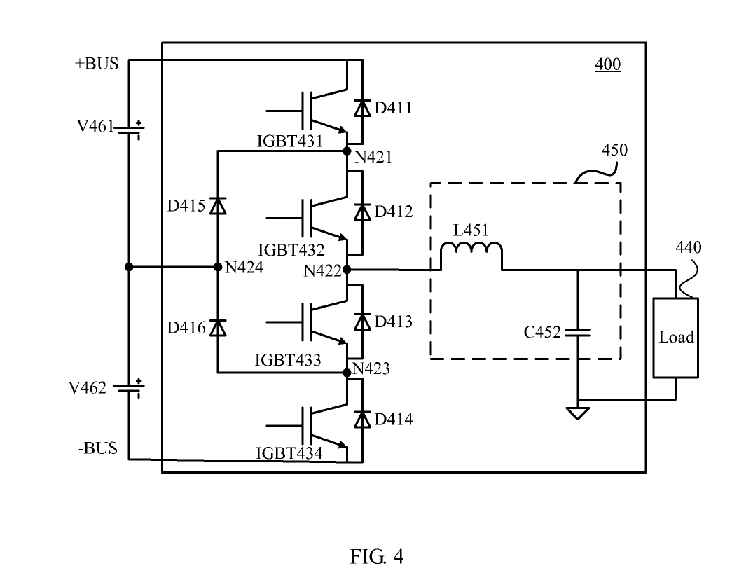

FIG. 4 is a schematic circuit structural diagram of a three-level inverter 400 according to yet another embodiment of the present application. The three-level inverter 400 includes: a first IGBT 431, a second IGBT 432, a third IGBT 433, a fourth IGBT 434, a first clamping diode D415, and a second clamping diode D416. The three-level inverter 400 in FIG. 4 is an example of the three-level inverter 200 in FIG. 2, and detailed descriptions herein are not provided properly.

A collector of the first IGBT 431 is connected to a positive pole of a DC voltage source V461, that is, a positive DC bus +BUS, an emitter of the first IGBT 431 is connected to a first connection point N421, and the collector and the emitter of the first IGBT 431 are bridge-connected to a first freewheeling diode D411. For example, an anode of the first freewheeling diode D411 is connected to the emitter of the first IGBT 431, and a cathode of the first freewheeling diode D411 is connected to the collector of the first IGBT 431.

A collector of the second IGBT 432 is connected to the first connection point N421, an emitter of the second IGBT 432 is connected to a second connection point N422, and the collector and the emitter of the second IGBT 432 are bridge-connected to a second freewheeling diode D412. For example, an anode of the second freewheeling diode D412 is connected to the emitter of the second IGBT 432, and a cathode of the second freewheeling diode D412 is connected to the collector of the second IGBT 432.

A collector of the third IGBT 433 is connected to the second connection point N422, an emitter of the third IGBT 233 is connected to a third connection point N223, and the collector and the emitter of the third IGBT 433 are bridge-connected to a third freewheeling diode D413. For example, an anode of the third freewheeling diode D413 is connected to the emitter of the third IGBT 433, and a cathode of the third freewheeling diode D413 is connected to the collector of the third IGBT 433.

A collector of the fourth IGBT 434 is connected to the third connection point N423, an emitter of the fourth IGBT 434 is connected to a negative pole of a DC voltage source V462, that is, a negative DC bus −BUS, and the collector and the emitter of the fourth IGBT 434 are bridge-connected to a fourth freewheeling diode D414. For example, an anode of the fourth freewheeling diode D414 is connected to the emitter of the fourth IGBT 434, and a cathode of the fourth freewheeling diode D414 is connected to the collector of the fourth IGBT 434.

The first clamping diode D415 is connected to the fourth connection point N424 and the first connection point N421. For example, an anode of the first clamping diode D415 is connected to the fourth connection point N424, and a cathode of the first clamping diode D415 is connected to the first connection point N421. The second clamping diode D416 is connected to the fourth connection point N424 ad the third connection point N423. For example, a cathode of the second clamping diode D416 is connected to the fourth connection point N424, and an anode of the second clamping diode D416 is connected to the third connection point N423, where the fourth connection point N424 is a neutral potential point, the second connection point N422 is an alternating current output connection point, switching speeds of the first IGBT 431 and the fourth IGBT 434 are higher than switching speeds of the second IGBT 432 and the third IGBT 433, or saturation turn-on voltage drops of the second IGBT 432 and the third IGBT 433 are lower than saturation turn-on voltage drops of the first IGBT 431 and the fourth IGBT 434.

Optionally, as another embodiment, the three-level inverter 400 may further include: a low-pass filter 450, connected between the second connection point N422 and a load 440. The low-pass filter may include a capacitor and/or an inductor. For example, the low-pass filter 450 may include an inductor L451 and a capacitor C452, where the inductor L451 and the load 440 are connected in series, the capacitor 452 and the load 440 are connected in parallel, and an end of the capacitor and an end of the load 440 are connected to the inductor 451, and the other ends are connected to the neutral point.

According to the embodiments of the present application, a negative pole of the DC voltage source V461 is connected to the fourth connection point N424, and a positive pole of the DC voltage source V462 is connected to the fourth connection point N424.

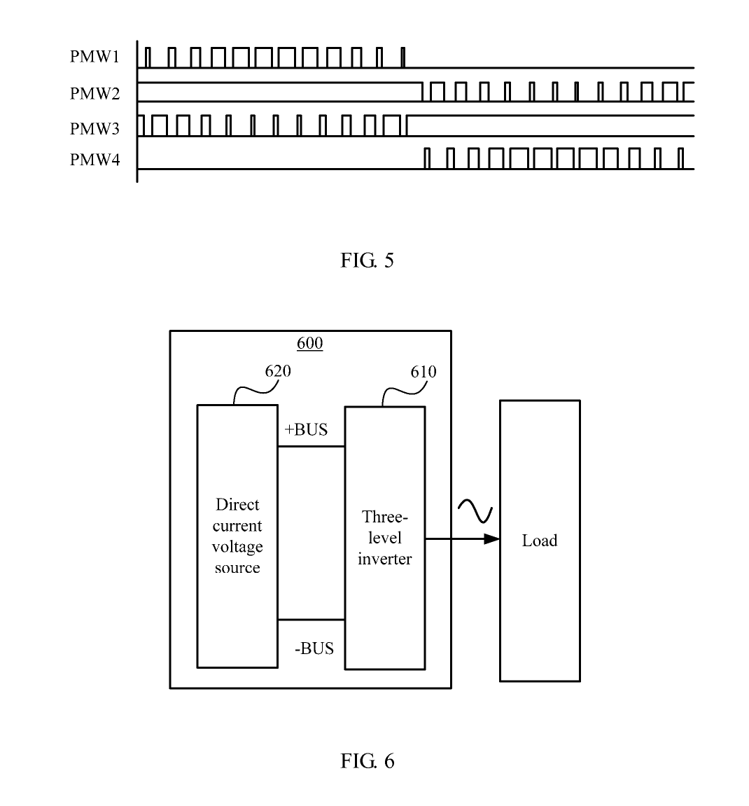

FIG. 5 is a sequence diagram of a control signal of a three-level inverter according to an embodiment of the present application. The control principles of the three-level inverter are described with reference to the embodiments of FIG. 2 and FIG. 5.

This embodiment is described by using the pulse width modulation (Pulse width modulation, PWM) control signal generated by the controller as an example. Refer to FIG. 5, PWM1-PWM4 are driving signals of the switch tubes IGBT 231, IGBT 232, IGBT 233, and IGBT 234. In the positive half-cycle, the IGBT 232 is normally open, the IGBT 234 is normally closed, and the IGBT 231 and the IGBT 233 are complementarily turned on and ensure the dead zone thereof according to the sinusoidal pulse width modulation (Sinusoidal PWM, SPWM). In the negative half-cycle, the IGBT 233 is normally open, the IGBT 231 is normally closed, and the IGBT 234 and the IGBT 232 are complementarily turned on and ensure the dead zone thereof according to the SPWM.

For convenience of description, the direction of the inductive current is defined: when the inductive current flows from the connection point N222 to a load end, the inductive current is defined as positive; and when the inductive current flows from the load end to the connection point N222, the inductive current is defined as negative.

When the voltage is in the positive half-cycle and the inductive current is positive, or the voltage is in the negative half-cycle and the inductive current is negative, losses of the outer switch tubes IGBT 231 and IGBT 234 include two parts: the switching loss and turn-on loss, and losses of the inner switch tubes IGBT 232 and IGBT 233 only includes the turn-on loss. Using the situation where the voltage is in the positive half-cycle and the inductive current is positive as an example, the IGBT 232 is normally open, and the IGBT 231 and the IGBT 233 are complementarily turned on. When the IGBT 231 is turned on, the inductive current IL flows through the IGBT 231 and the IGBT 232; and when the IGBT 231 is turned off, the inductive current IL commutates to the D215 and the IGBT 232, and therefore the loss of the outer switch tube IGBT 231 includes the switching loss and turn-on loss, the inner switch tube IGBT 232 only has the turn-on loss, while no current flows through the IGBT 233, and the IGBT 233 has no switching loss and turn-on loss. When a resistive load is connected, and because the proportion of the turn-off loss of an outer switch tube is large, the switching loss may be reduced by using the IGBT 231 and the IGBT 234 which have higher switching speeds; and because the proportion of the switching loss of an inner switch tube is small while the proportion of the turn-on loss is large, the turn-on loss may be reduced by using the IGBT 232 and the IGBT 233 which have slow switching speeds and small saturation turn-on voltage drops as inner switch tubes. Therefore, when the outer switch tubes are high-speed IGBTs, and the inner switch tubes are low-speed IGBTs, the switching losses of the outer switch tubes and the turn-on losses of the inner switch tubes may be reduced, and the total losses of the inner switch tubes and the outer switch tubes are reduced as a whole, thereby improving the conversion efficiency of the inverter.

Further, when the outer switch tubes IGBT 231 and IGBT 234 are turned off, the commutation path of the inductive current is short, and therefore the voltage stresses are relatively small when the outer switch tubes are turned off; and when the inner switch tubes IGBT 232 and IGBT 233 are turned off, the commutation path of the inductive current is long, and therefore the voltage stresses are large when the inner switch tubes are turned off. Specifically, for example, when an outer switch tube is the IGBT 231, the inductive current IL flows through the IGBT 231 and the IGBT 232, when the IGBT 231 is turned off, the inductive current IL commutates to the D215 and the IGBT 232; and during the commutation process, the current originally flowing through the IGBT 231 is reducing, while the current flowing through the D215 is increasing, the induced voltage generated by the parasitic inductor on the line is superimposed to both ends of the IGBT 231, which makes the IGBT 231 generate a voltage spike. For example, an inner switch tube is the IGBT 232, the inductive current IL flows through the D215 and the IGBT 232, and when the IGBT 232 is turned off, the inductive current IL commutates to the D213 and the D214. During the commutation process, the current originally flowing through the IGBT 232 is reducing, while the current flowing through the D213 and the D214 is increasing, the induced voltage generated by the parasitic inductor on the line is superimposed to both ends of the IGBT 232, which makes the IGBT 232 generate a voltage spike. It can be learned from the above analysis that, the commutation paths of the outer switch tubes IGBT 231 and IGBT 234 are shorter than the commutation paths of the inner switch tubes IGBT 232 and IGBT 233, and the voltage stresses of the IGBT 231 and IGBT 234 are smaller. It can be learned from the above analysis that, the switching speeds of the outer switch tubes may be higher than the switching speeds of the inner switch tubes.

Therefore, according to the embodiments of the present application, the switching speeds of the outer switch tubes of the three-level inverter are higher than the switching speeds of the inner switch tubes, or the saturation turn-on voltage drops of the inner switch tubes are lower than the saturation turn-on voltage drops of the outer switch tubes, so as to achieve a suitable balance between the improvement of the conversion efficiency of the three-level inverter and the reduction of the voltage stresses of the switch tubes, that is, to reduce the voltage stresses of the switch tubes while improving the conversion efficiency of the three-level inverter.

FIG. 6 is a schematic structural diagram of power supply equipment 600 according to an embodiment of the present application. The power supply equipment 600 includes: a three-level inverter 610 and a DC voltage source 620. The three-level inverter 610 may be realized by any one of the three-level inverter 200, three-level inverter 300, and three-level inverter 400 in the embodiments shown in FIG. 2-FIG. 4.

A positive pole of the DC voltage source 620 is connected to a positive DC bus +BUS, and a negative pole of the DC voltage source 610 is connected to a negative DC bus −BUS.

According to the embodiments of the present application, the three-level inverter 610 includes: a first insulated gate bipolar transistor IGBT, where a collector of the first IGBT is connected to the positive DC bus, an emitter of the first IGBT is connected to a first connection point, and the collector and the emitter of the first IGBT are bridge-connected to a first freewheeling diode; a second IGBT, where a collector of the second IGBT is connected to the first connection point, an emitter of the second IGBT is connected to a second connection point, and the collector and the emitter of the second IGBT are bridge-connected to a second freewheeling diode; a third IGBT, where a collector of the third IGBT is connected to the second connection point, an emitter of the third IGBT is connected to a third connection point, and the collector and the emitter of the third IGBT are bridge-connected to a third freewheeling diode; a fourth IGBT, where a collector of the fourth IGBT is connected to the third connection point, an emitter of the fourth IGBT is connected to the negative DC bus, and the collector and the emitter of the fourth IGBT are bridge-connected to a fourth freewheeling diode; a first clamping diode, connected to a fourth connection point and the first connection point; and a second clamping diode, connected to the fourth connection point and the third connection point, where the fourth connection point is a neutral potential point, the second connection point is an alternating current output connection point, switching speeds of the first IGBT and the fourth IGBT are higher than switching speeds of the second IGBT and the third IGBT, or saturation turn-on voltage drops of the second IGBT and the third IGBT are lower than saturation turn-on voltage drops of the first IGBT and the fourth IGBT.

According to the embodiments of the present application, turn-off losses of the first IGBT and the fourth IGBT are smaller than turn-off losses of the second IGBT and the third IGBT; or turn-on losses of the first IGBT and the fourth IGBT are smaller than turn-on losses of the second IGBT and the third IGBT; or turn-off time of the first IGBT and the fourth IGBT is shorter than turn-off time of the second IGBT and the third IGBT; or turn-on time of the first IGBT and the fourth IGBT is shorter than turn-on time of the second IGBT and the third IGBT.

Optionally, as another embodiment, the three-level inverter further includes: a low-pass filter, connected between the second connection point and the load, and configured to filter an alternating current signal output by the second connection point.

Optionally, as another embodiment, the three-level inverter further includes: a controller, where an output end of the controller is connected to a grid electrode of the first IGBT, a grid electrode of the second IGBT, a grid electrode of the third IGBT and a grid electrode of the fourth IGBT; and the controller is configured to control the turn-on and turn-off of the first IGBT, the second IGBT, the third IGBT, and the fourth IGBT according to a preset pulse width modulation rule, so as to output the alternating current signal at the second connection point.

Optionally, as another embodiment, the three-level inverter further includes: a first capacitor, connected between the positive DC bus and the fourth connection point; and a second capacitor, connected between the negative DC bus and the fourth connection point.

A person of ordinary skill in the art may be aware that, with reference to the examples described in the embodiments disclosed in this specification, units and algorithm steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

It may be clearly understood by a person skilled in the art that, for the purpose of convenient and brief description, a detailed working process of the foregoing system, apparatus, and unit may refer to the corresponding process in the foregoing method embodiments, and the details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the present application essentially, or the part contributing to the prior art, or a part of the technical solutions may be implemented in a form of a software product. The computer software product is stored in a storage medium, and includes several instructions for instructing a computer device (which may be a personal computer, a server, or a network device) to perform all or a part of the steps of the methods described in the embodiments of the present application. The foregoing storage medium includes: any medium that can store program codes, such as a USB flash disk, a removable hard disk, a read-only memory (Read-Only Memory, ROM), a random access memory (Random Access Memory, RAM), a magnetic disk, or an optical disc.

The foregoing descriptions are merely specific embodiments of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

1. A three-level inverter, comprising:
a first insulated gate bipolar transistor (IGBT), wherein a collector of the first IGBT is connected to a positive direct current bus, an emitter of the first IGBT is connected to a first connection point, and the collector and the emitter of the first IGBT are bridge-connected to a first freewheeling diode;
a second IGBT, wherein a collector of the second IGBT is connected to the first connection point, an emitter of the second IGBT is connected to a second connection point, and the collector and the emitter of the second IGBT are bridge-connected to a second freewheeling diode;
a third IGBT, wherein a collector of the third IGBT is connected to the second connection point, an emitter of the third IGBT is connected to a third connection point, and the collector and the emitter of the third IGBT are bridge-connected to a third freewheeling diode;
a fourth IGBT, wherein a collector of the fourth IGBT is connected to the third connection point, an emitter of the fourth IGBT is connected to a negative direct current bus, and the collector and the emitter of the fourth IGBT are bridge-connected to a fourth freewheeling diode;
a first clamping diode, connected to a fourth connection point and the first connection point; and
a second clamping diode, connected to the fourth connection point and the third connection point, wherein the fourth connection point is a neutral potential point, the second connection point is an alternating current output connection point, switching speeds of the first IGBT and the fourth IGBT are higher than switching speeds of the second IGBT and the third IGBT, or saturation turn-on voltage drops of the second IGBT and the third IGBT are lower than saturation turn-on voltage drops of the first IGBT and the fourth IGBT.

2. The three-level inverter according to claim 1, wherein
turn-off losses of the first IGBT and the fourth IGBT are smaller than turn-off losses of the second IGBT and the third IGBT.

3. The three-level inverter according to claim 1, further comprising:
a low-pass filter, connected between the second connection point and a load, and configured to filter an alternating current signal output by the second connection point.

4. The three-level inverter according to claim 1, further comprising:
a controller, wherein an output end of the controller is connected to a grid electrode of the first IGBT, a grid electrode of the second IGBT, a grid electrode of the third IGBT, and a grid electrode of the fourth IGBT; and the controller is configured to control turn-on and turn-off of the first IGBT, the second IGBT, the third IGBT, and the fourth IGBT according to a preset pulse width modulation rule, so as to output the alternating current signal at the second connection point.

5. The three-level inverter according to claim 1, further comprising:
a first capacitor, connected between the positive direct current bus and the fourth connection point; and
a second capacitor, connected between the negative direct current bus and the fourth connection point.

6. A power supply equipment, comprising: a three-level inverter and a direct current voltage source, wherein a positive pole of the direct current voltage source is connected to a positive direct current bus, and a negative pole of the direct current voltage source is connected to a negative direct current bus;
wherein the three-level inverter comprises: a first insulated gate bipolar transistor (IGBT), wherein a collector of the first IGBT is connected to the positive direct current bus, an emitter of the first IGBT is connected to a first connection point, and the collector and the emitter of the first IGBT are bridge-connected to a first freewheeling diode;
a second IGBT, wherein a collector of the second IGBT is connected to the first connection point, an emitter of the second IGBT is connected to a second connection point, and the collector and the emitter of the second IGBT are bridge-connected to a second freewheeling diode;
a third IGBT, wherein a collector of the third IGBT is connected to the second connection point, an emitter of the third IGBT is connected to a third connection point, and the collector and the emitter of the third IGBT are bridge-connected to a third freewheeling diode;
a fourth IGBT, wherein a collector of the fourth IGBT is connected to the third connection point, an emitter of the fourth IGBT is connected to a negative direct current bus, and the collector and the emitter of the fourth IGBT are bridge-connected to a fourth freewheeling diode;
a first clamping diode, connected to a fourth connection point and the first connection point; and
a second clamping diode, connected to the fourth connection point and the third connection point, wherein the fourth connection point is a neutral potential point, the second connection point is an alternating current output connection point, switching speeds of the first IGBT and the fourth IGBT are higher than switching speeds of the second IGBT and the third IGBT, or saturation turn-on voltage drops of the second IGBT and the third IGBT are lower than saturation turn-on voltage drops of the first IGBT and the fourth IGBT.

7. The power supply equipment according to claim 6, wherein
turn-off losses of the first IGBT and the fourth IGBT are smaller than turn-off losses of the second IGBT and the third IGBT.

8. The power supply equipment according to claim 6, wherein the three-level inverter further comprises:
a low-pass filter, connected between the second connection point and a load, and configured to filter an alternating current signal output by the second connection point.

9. The power supply equipment according to claim 6, wherein the three-level inverter further comprises:
a controller, wherein an output end of the controller is connected to a grid electrode of the first IGBT, a grid electrode of the second IGBT, a grid electrode of the third IGBT, and a grid electrode of the fourth IGBT; and the controller is configured to control turn-on and turn-off of the first IGBT, the second IGBT, the third IGBT, and the fourth IGBT according to a preset pulse width modulation rule, so as to output the alternating current signal at the second connection point.

10. The power supply equipment according to claim 6, wherein the three-level inverter further comprises:
a first capacitor, connected between the positive direct current bus and the fourth connection point; and
a second capacitor, connected between the negative direct current bus and the fourth connection point.

11. The three-level inverter according to claim 1, wherein
turn-on losses of the first IGBT and the fourth IGBT are smaller than turn-on losses of the second IGBT and the third IGBT.

12. The three-level inverter according to claim 1, wherein
turn-off time of the first IGBT and the fourth IGBT is shorter than turn-off time of the second IGBT and the third IGBT.

13. The three-level inverter according to claim 1, wherein
turn-on time of the first IGBT and the fourth IGBT is shorter than turn-on time of the second IGBT and the third IGBT.

14. The power supply equipment according to claim 6, wherein
turn-on losses of the first IGBT and the fourth IGBT are smaller than turn-on losses of the second IGBT and the third IGBT.

15. The power supply equipment according to claim 6, wherein
turn-off time of the first IGBT and the fourth IGBT is shorter than turn-off time of the second IGBT and the third IGBT.

16. The power supply equipment according to claim 6, wherein
turn-on time of the first IGBT and the fourth IGBT is shorter than turn-on time of the second IGBT and the third IGBT.
